(19) United States
(12) Patent Application Publication
(10) Pub. No.: US 2011/0110734 A1
(43) Pub. Date: May 12, 2011

(54) POWER TOOL CONFIGURED FOR SUPPORTING A REMOVABLE ATTACHMENT

(76) Inventors: David Leigh Scrimshaw, Victoria (AU); Benjamin Luke Van der Linde, Victoria (AU); Paul Francis Connor, Victoria (AU); Paul Miller, Victoria (AU)

(21) Appl. No.: 13/000,970

(22) PCT Filed: Jun. 26, 2009
(86) PCT No.: PCT/AU09/00825

§ 371 Date: Jan. 19, 2011

(30) Foreign Application Priority Data
Jun. 27, 2008 (AU) 2008903300

(51) Int. Cl. B25F 5/00; B23B 49/00

(52) U.S. Cl. 408/16; 173/46

(57) ABSTRACT

This invention relates to a power tool, an accessory and a power tool and accessory system. The power tool includes a tool body and a rotatable driven member extending forward from the tool body for gripping and rotating a working element about an axis of rotation. The power tool also includes a cover surrounding the driven member having opposite rearward and forward ends with the rearward end being directly connected to the tool body so that the cover does not to rotate with the driven member. The cover includes at least one accessory attachment facility configured to facilitate releasable attachment of an accessory to the cover between the rearward and forward ends along the direction of the axis of rotation of the driven member. The power tool accessory includes at least one power tool attachment facility configured to facilitate releasable attachment of the accessory to the cover between the rearward and forward ends along the direction of the axis of rotation of the driven member. The power tool and accessory system includes a power tool and an accessory. The power tool has a tool body, a rotatable driven member extending forward from the tool body for gripping and rotating a working element about an axis of rotation, a cover surrounding the driven member having opposite rearward and forward ends with the rearward end being directly connected to the tool body so that the cover does not rotate with the driven member, the cover being configured to facilitate releasable attachment of the accessory to the cover between the rearward and forward ends along the direction of the axis of rotation of the driven member.

### FIELD OF THE INVENTION

The present invention relates to hand held power tools configured for supporting a removal attachment as well as removable attachments for such power tools. The present invention is particularly useful in relation to hand held power drills. For this reason, the invention will be discussed below in the context of hand held power drills, however, it is to be appreciated that the invention may have broader application.

### BACKGROUND OF THE INVENTION

Hand held power drills typically include a housing, a power drive disposed within the housing, a handle and trigger located towards the rear of the housing and a chuck located forward of the front of the housing. The chuck is configured to receive a drill or screwdriver bit and when a user gripping the power tool operates the trigger the power drive means is operable to drive rotation of the chuck and thereby rotate the bit to perform work on a workpiece.

Most hand held power drills are configured to serve a single function of driving rotation of a bit to perform work on a workpiece. Some hand held power drills are configured with accessories that enable the drill to serve more than one function or to enhance the primary drilling or driving function.

Existing means of connecting attachments to power drills involve connecting the attachment directly to either the chuck or to the housing. When an attachment is connected to the chuck of a power drill and the chuck rotates when the drill is in use the attachment rotates with the chuck. For some attachments, it is not desirable for the attachment to be rotated when the drill is in use.

When an attachment is connected to the housing of a power drill and a bit is attached to the power drill chuck, the bit is located a significant distance forward from the power drill housing and the point of connection between the attachment and the housing. For some attachments, the usefulness of the attachment in achieving its desired function is reduced the further away it is connected to the power drill from the bit.

### SUMMARY OF THE INVENTION

Accordingly, the present invention seeks to ameliorate the above problems by providing, in a first aspect, a power tool including:

a tool body

a rotatable driven member extending forward from the tool body for gripping and rotating a working element about an axis of rotation;

a cover surrounding the driven member having opposite rearward and forward ends with the rearward end being directly connected to the tool body so that the cover does not to rotate with the driven member, the cover including at least one accessory attachment facility configured to facilitate releasable attachment of an accessory to the cover between the rearward and forward ends along the direction of the axis of rotation of the driven member.

The above form is advantageous in that the cover provides a stable means for supporting an attachment by not rotating with the driven member. Furthermore, by facilitating releasable attachment of an accessory between its rearward and forward ends along the direction of the axis of rotation of the driven member, the cover provides a means of attachment of the accessory to the power tool in a location that is relatively close to the driven member and any working element associated with the driven member.

In one form, the accessory attachment facility is positioned on a radially outwardly facing surface of the cover between the rearward and forward ends along the direction of the axis of rotation of the driven member, the accessory attachment facility being configured for releasable attachment of an accessory to the radially outwardly facing surface of the cover.

The above form is advantageous in that it facilitates ease of attachment and removal of an accessory to the cover by providing for attachment to a radially outwardly facing surface thereof. By attaching to a radially outwardly facing surface of the cover, the accessory is securely attached thereto and the means of attachment therebetween may be readily accessible by a user for either attachment or removal.

In another form, the accessory attachment facility is configured for releasable attachment of an accessory to the cover in a position that is radially spaced apart from the axis of rotation of the driven member.

In yet another form, the accessory attachment facility is configured for releasable attachment of an accessory to the cover in at least two positions on opposite sides of the axis of rotation of the driven member.

The above forms are advantageous in that the accessory is maintained in a stable position relative to the axis of rotation of the driven member.

The accessory attachment facility may include an opening for receiving therethrough an elongate member for fastening an accessory to the cover.

The opening may include a thread for engagement with a respective threaded elongate member received therethrough for fastening an accessory to the cover.

The cover may be made up of a separate first and second cover portions.

The accessory attachment facility may be provided by removably coupling the first and second cover portions together and securing an accessory therebetween.

In one form, the first and second cover portions include a pair of opposing surfaces that are configured to clamp an accessory therebetween when the first and second cover portions are coupled together.

In another form, the pair of opposing surfaces are oriented substantially perpendicularly to the axis of rotation of the driven member.

In yet another form, the first and second cover portions include respective first and second threads that are operable to mate together and thereby couple the first and second cover portions together.

One of the first and second cover portions may include a projection that fits into a passage within the other one of the first and second cover portions when the first and second cover portions are coupled together.

The projection may be a hollow cylindrical projection that extends substantially in the direction of the axis of rotation of the driven member.

The projection may include a radially outwardly facing surface with an elongate rib or groove extending in the direction of the axis of rotation of the driven member for engaging a respective groove or rib on an accessory to prevent rotational movement of the accessory relative to the cover.

In one form, the first cover portion and the second cover portion mey be rotatable relative to each other.

In another form, rotation of one of the first and second cover portions relative to the tool body is operable for selecting a function of the power tool.

In yet another form, the accessory attachment facility includes a radially outwardly facing annular surface of the cover extending in substantially the same direction as the axis of rotation of the driven member, wherein the annular surface is configured for face to face engagement with a radially inwardly facing annular mounting surface of an accessory.

The cover may have a tapered surface between the accessory attachment facility and the forward end.

In one form, the cover includes a second accessory attachment facility configured for releasable attachment of an accessory thereto between the rearward and forward ends of the cover, the accessory attachment facilities being spaced apart from each other along the direction of the axis of rotation of the driven member.

In another form, the second accessory attachment facility is configured to support an accessory in alignment relative to the axis of rotation of the driven member.

In yet another form, the second accessory attachment facility includes a radially outwardly facing annular surface of the cover extending in substantially the same direction as the axis of rotation of the driven member, wherein the annular surface is configured for face to face engagement with a radially inwardly facing annular mounting surface of an accessory.

In still yet another form, the cover includes a third accessory attachment facility configured for releasable attachment of an accessory thereto between the rearward and forward ends of the cover, the accessory attachment facilities being spaced apart from each other along the direction of the axis of rotation of the driven member.

The above forms are advantageous in that compared with an arrangement in which the accessory is attached to the cover by only one accessory attachment facility along the axis of rotation of the driven member, the attachment of the accessory to the cover via at least two accessory attachment facilities that are spaced apart in the direction of the axis of rotation of the driven member provides additional stability between the accessory and the cover and/or additional stability between the accessory and the axis of rotation of the driven member. Also, the above forms of the invention are advantageous in that they facilitate releasable attachment of more than one accessory to the cover at different positions along the axis of rotation of the driven member.

In another aspect, the invention provides a power tool accessory configured for use with a power tool having a tool body, a rotatable driven member extending forward from the tool body for gripping and rotating a working element about an axis of rotation and a cover surrounding the driven member having opposite rearward and forward ends with the rearward end being directly connected to the tool body so that the cover does not to rotate with the driven member, the cover being configured to facilitate releasable attachment of an accessory to the cover between the rearward and forward ends along the direction of the axis of rotation of the driven member, the accessory including at least one power tool attachment facility configured to facilitate releasable attachment of the accessory to the cover between the rearward and forward ends along the direction of the axis of rotation of the driven member.

The accessory may include an annular mounting ring for receiving an annular surface of the cover therethrough.

The annular mounting ring may include a pair of opposite annular surfaces configured to be clamped between a pair of opposing surfaces of first and second portions of the cover.

In one form, the annular mounting ring is an at least partially enclosed circular ring.

In another form, the annular mounting ring includes a radially inwardly facing annular surface with a rib or groove for engaging a respective groove or rib of the cover to prevent rotational movement of the accessory relative to the cover.

In one form, the rib or groove of the annular mounting ring extends in the direction of the axis of rotation of the driven member when the annular mounting ring is secured to the cover of the power tool.

The annular mounting ring may include a radially inwardly facing annular surface configured for face to face engagement with a radially outwardly facing annular surface of the cover.

The accessory may include a tapered surface configured for contact with a tapered surface of the cover.

In one form, the power tool attachment facility is positionable on a radially outwardly facing surface of the cover between the rearward and forward ends along the direction of the axis of rotation of the driven member, the power tool attachment facility being configured for releasable attachment of the cover to the accessory.

In another form, the power tool attachment facility is configured for releasable attachment of the cover to the accessory in a position that is radially spaced apart from the axis of rotation of the driven member.

In yet another form, the power tool attachment facility is configured for releasable attachment of the cover to the accessory in at least two positions on opposite sides of the axis of rotation of the driven member.

In still yet another form, the power tool attachment facility includes an opening for receiving therethrough an elongate member for fastening the cover to the accessory.

The opening may include a thread for engagement with a respective threaded elongate member received therethrough for fastening the cover to the accessory.

The accessory may include a second power tool attachment facility configured for releasable attachment to the cover between the rearward and forward ends of the cover, the power tool attachment facilities being spaced apart from each other along the direction of the axis of rotation of the driven member.

In one form, the second power tool attachment facility is configured to support the accessory in alignment relative to the axis of rotation of the driven member.

In one form, the accessory is a light emitting device.

In another form, the accessory is a drill plunge depth guide.

The drill plunge depth guide may include a workpiece contacting member having an aperture for a working element to pass therethrough, at least one elongate member extending substantially in the direction of the axis of rotation of the driven member between the workpiece contacting member and the cover to facilitate releasable attachment of the workpiece contacting member to the cover.

In one form, an effective length of the elongate member between the workpiece contacting member and the cover may be adjustable to facilitate adjustment of the plunge depth of the working element into the workpiece.

In another form, the accessory is a dust shroud.

The dust shroud may include a disc shaped member oriented substantially transversely to the axis of rotation of the driven member, a connecting portion extending between the disc shaped member and the cover being configured to facilitate releasable attachment of the shroud to the cover.

In another form, the accessory is a gearbox.

The gearbox may include an input shaft, an output shaft and a gear assembly therebetween, the input shaft is configured to be rotated by the driven member and transmit rotation via the gear assembly to the output shaft and the gear assembly is configured to cause the output shaft to rotate at a relatively different speed to the speed of rotation of the driven member.

In another form, the accessory is a paint stirring attachment.

In another aspect, the invention provides a power tool and accessory system including a power tool and an accessory, the power tool having a tool body, a rotatable driven member extending forward from the tool body for gripping and rotating a working element about an axis of rotation, a cover surrounding the driven member having opposite rearward and forward ends with the rearward end being directly connected to the tool body so that the cover does not to rotate with the driven member, the cover being configured to facilitate releasable attachment of the accessory to the cover between the rearward and forward ends along the direction of the axis of rotation of the driven member.

In one form, the power tool and accessory system includes any one of the embodiments of the power tool defined above.

In another form, the power tool and accessory system includes any one of the embodiments of the accessory defined above.

### BRIEF DESCRIPTION OF THE DRAWINGS

It will be convenient to hereinafter describe the invention in greater detail by reference to the accompanying drawings which show preferred embodiments of the invention. The particularity of the drawings and the related detailed description is not to be understood as superseding the generality of the preceding broad description of the invention.

FIG. 1 illustrates a side view of a power drill including a cover which surrounds a driven member in the form of a chuck hidden beneath the cover.

FIG. 2 illustrates a perspective view of the cover of FIG. 1 in which the cover is formed out of first and second cover portions.

FIG. 3 illustrates a perspective view of the cover of FIG. 1 in which the first and second cover portions are connected together.

FIG. 4 illustrates a perspective view of the cover of FIG. 1 in which the first and second cover portions are separated from each other and in which an accessory in the form of a light emitting device is positioned between the first and second cover portions.

FIG. 5 illustrates a perspective view of the cover of FIG. 1 in which the first and second cover portions are connected together with the light emitting device fixed in position between the first and second cover portions.

FIG. 6 illustrates a perspective view of another embodiment of the cover of FIG. 1 as well as a dust shroud and a means for connecting the dust shroud to the cover.

FIG. 7 illustrates the cover and the dust shroud of FIG. 6 connected together.

FIG. 8 illustrates another embodiment of the cover of FIG. 1 as well as another form of accessory in the form of a drill plunge depth control guide accessory in exploded form.

FIG. 9 illustrates a perspective view of the cover and drill plunge depth control accessory of FIG. 8 in assembled form and with the cover and accessory attached together.

FIG. 10 illustrates a perspective view of the cover of FIG. 8 as well as an accessory in the form of a rotation speed reduction gearbox.

FIG. 11 illustrates a perspective view of the cover and rotation speed reduction gearbox of FIG. 10 wherein the cover and the rotation reduction gearbox are connected together.

FIG. 12 illustrates a side view of the cover and rotation speed reduction gearbox of FIGS. 10 and 11 wherein the cover and the rotation speed reduction gearbox are connected together.

FIG. 13 illustrates a cross section view of the cover and rotation speed reduction gearbox of FIGS. 10 to 12 taken along the section line C-C of FIG. 12 and components of a driven member in the form of a chuck surrounded by the cover and internal components of the rotation speed reduction gearbox.

FIG. 14 illustrates a perspective view of a cover is made up of a first cover portion and a second cover portion in accordance with another form of the invention.

FIG. 15 illustrates a side view of the cover of FIG. 14.

### DETAILED DESCRIPTION

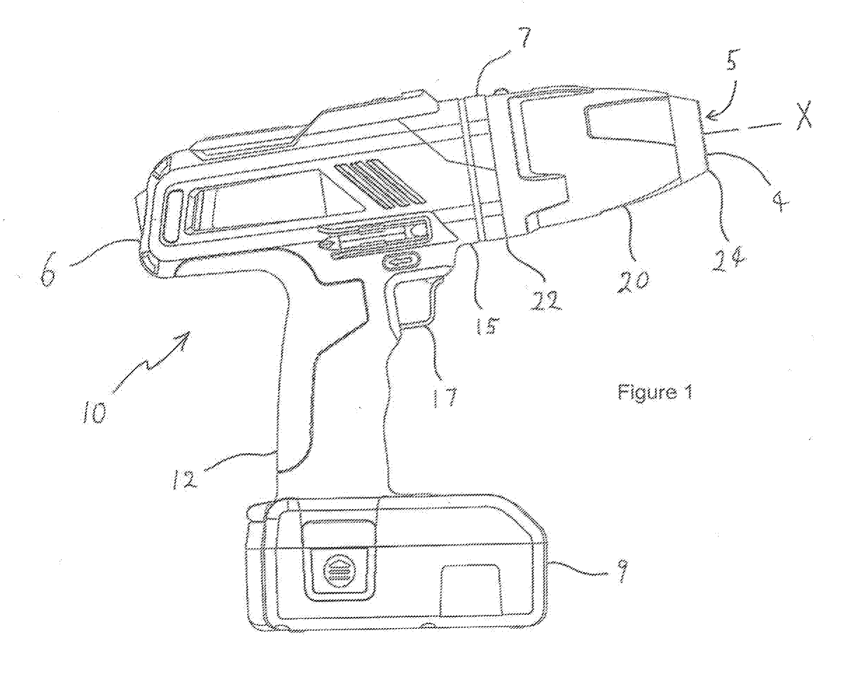

Referring to FIG. 1 there is shown a hand held power tool in the form of a power drill 10. The power drill 10 includes a tool body 15 and a handle 12 extending substantially transversely from a rear end 6 of the tool body 15. A trigger 17 is arranged on the handle 12 for operation by a user gripping the handle 12 to activate the power drill 10. A rechargeable energy storage pack 9 is releasably attachable to a portion of the handle 12 that is distal from the tool body 15. Although in the embodiment illustrated in the figures the rechargeable energy storage pack 9 is releasably attachable to the handle 12, it is to be appreciated that the rechargeable energy storage pack 9 may be permanently fixed to, or disposed within, the handle 12 or the tool body 15. Encased within the tool body 15 is a power drive (not shown) which may be in the form of an electric motor. The electric motor is connected to a driven member (not shown) which may be in the form of a chuck. The chuck is enclosed within a cover 20 which extends from, and is connected to, a front end 7 of the tool body 15. Accordingly, the cover 20 includes an internal hollow opening 5 for receiving the driven member of the power tool 10 therewithin.

As shown in FIG. 1, the cover 20 includes a rearward end 22 and a forward end 24 with the rearward end 22 being directly connected to the front end 7 of the tool body 15. As mentioned above, the cover 20 surrounds a chuck (not shown) that is configured to releasably hold a working element such as a drill or screw driver bit. The driven member is configured for releasable connection with the working element such as a drill or screwdriver bit (not shown) which protrudes through a forward opening 4 at the forward end 24 of the cover 20. The chuck is configured to rotate about an axis of rotation X due to operation of the motor upon manipulation of the trigger 17 by a user. Rotation of the chuck whilst holding a drill or screw driver bit enables work to be carried out on a workpiece such as a piece of timber, masonry, a screw or any other type of workpiece which can be worked on by a drill or screw driver bit. An advantage of the cover 20 is that it shields the rotating chuck and reduces the ingress of dust and other contaminants into the chuck and prevents a user's hair or clothing from coming into contact with the chuck.

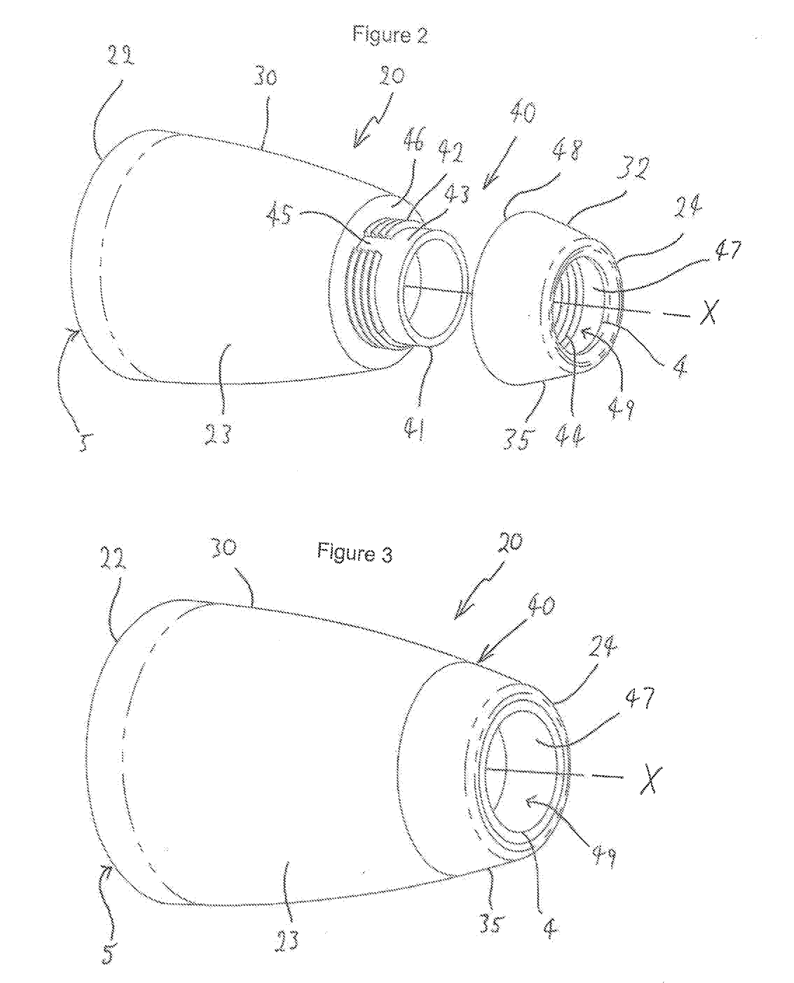

Referring to FIGS. 2 to 5, one embodiment of the cover 20 is shown in which the cover 20 is made up of a first cover portion 30 and a second cover portion 32. The cover 20 includes the internal hollow opening 5 for receiving the driven member of the power tool 10 therewithin. The first cover portion 30 and the second cover portion 32 are each substantially frusto-conical in shape and are configured to be removably coupled together. To achieve removable coupling of the first cover portion 30 and the second cover portion 32, the first cover portion 30 includes a hollow cylindrical projection 41 having a radially outward facing surface 43 with a first thread 42 disposed thereon. The second cover portion 32 includes a passage 49 configured to receive the hollow cylindrical projection 41 therewithin. The passage 49 includes a radially inwardly facing surface 47 and a second thread 44 disposed thereon. The first thread 42 and the second thread 44 are configured to mate with each other upon insertion of the hollow cylindrical projection 41 into the passage 49 to removably couple the first cover portion 30 and the second cover portion 32 together.

In the embodiment illustrated in FIGS. 1 to 5, the cover 20 includes a first accessory attachment facility 40. The first accessory attachment facility 40 is made up of the removable coupling of the first cover portion 30 and the second cover portion 32 together. The first cover portion 30 includes a first annular accessory clamping surface 46 which is flanged substantially transversely from the hollow cylindrical projection 41. Thus, the first annular accessory clamping surface 46 extends perpendicularly to the axis of rotation X of the driven member. The second cover portion 32 includes a second annular accessory clamping surface 48 that is substantially perpendicular to the radially inwardly facing surface 47 of the second cover portion 32 and also to the axis of rotation X of the driven member. Thus, the first annular accessory clamping surface 46 and the second annular accessory clamping surface 48 are configured to face each other in opposing relation when the first cover portion 30 and the second cover portion 32 are coupled together.

The first cover portion 30 includes a first external tapered surface 23 that extends from the rearward end 22 of the cover 20 to the first annular accessory clamping surface 46. The second cover portion 32 includes a second external tapered surface 35 that extends from the second annular accessory clamping surface 48 to the forward end 24 of the cover 20. When the first cover portion 30 and the second cover portion 32 are coupled together the first external tapered surface 23 and the second external tapered surface 35 combine to provide a substantially continuous tapered surface extending from the rearward end 22 to the forward end 24 of the cover 20.

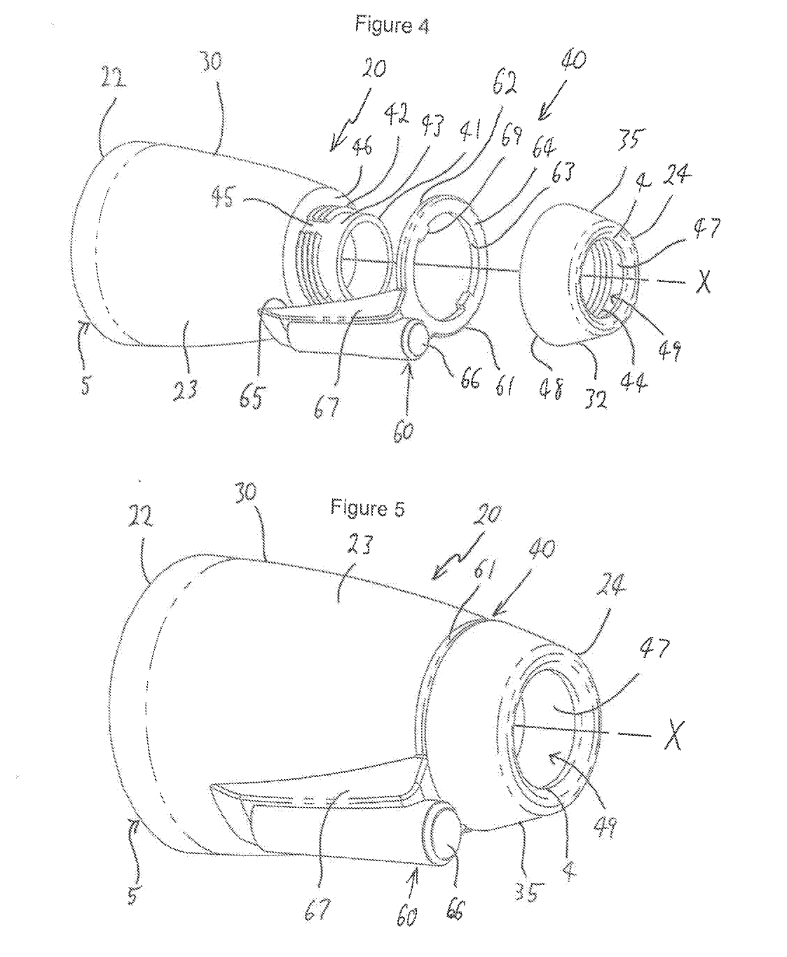

The opposing first and second annular accessory clamping surfaces 46, 48 are configured to clamp an attachment therebetween when the first and second cover portions 30, 32 are coupled together. Referring to FIGS. 4 and 5, an accessory 60 in the form of a light emitting device is interposed between the first cover portion 30 and the second cover portion 32 such that when the first and second cover portions 30, 32 are coupled together the accessory 60 is clamped therebetween. The accessory 60 includes an annular ring portion 61 which may be a partially or full enclosed ring. The accessory 60 includes a main body portion 67 connected to the ring 61. The main body portion 67 incorporates a light emitting portion 66 however it is to be appreciated that the main body portion 67 may incorporate any other type of functional accessory such as an electronic, electrical, electromechanical or other non-electronic or electrical devices. The ring 61 includes a first annular clampable surface 62 and an opposite second annular clampable surface 64 connected by a radially inwardly facing annular mounting surface 63. The radially inwardly facing annular mounting surface 63 is configured to be slid over the hollow cylindrical projection 41 of the first cover portion 30 such that the first annular clampable surface 62 comes into face to face abutment with the first annular accessory clamping surface 46. The second cover portion is then screwed onto the hollow cylindrical projection 41 such that the second annular clampable surface 64 comes into face to face abutment with the second annular accessory clamping surface 48. The abutment of the first annular clampable surface 62 with the first annular accessory clamping surface 46 and the abutment of the second annular clampable surface 64 with the second annular accessory clamping surface 48 results in clamping engagement of the annular mounting ring 61 between the first and second annular accessory clamping surfaces 46, 48. Thus, the accessory 60 is securely and releasably secured between the first cover portion 30 and a second cover portion 32 and to the cover 20 in general as shown in FIG. 5.

The above embodiment of the cover 20 is advantageous in that it facilitates easy attachment and removal of the accessory 60 to the cover 20 by simply screwing and unscrewing the second cover portion 32 from the first cover portion 30 and interposing the annular mounting ring 61 of the accessory 60 therebetween. The main body portion 67 of the accessory 60 includes a radially inwardly facing tapered surface 65 which extends substantially in the direction of the axis of rotation of the driven member X and over the external tapered surface 23 of the first cover portion 30. The external tapered surface 23 extends from the first annular accessory clamping surface 46 towards the rearward end 22 of the cover 20. The tapered surface 65 of the accessory 60 and the external tapered surface 23 of the first cover portion 30 abut against each other to provide support for, and alignment of, the accessory 60 relative to the axis of rotation of the driven member X.

Referring to FIG. 4, the annular mounting ring 61 of the accessory 60 includes a rib 69 which extends inwardly from the radially inwardly facing annular mounting surface 63. The rib 69 is configured to be received in a corresponding groove 45 on the radially outwardly facing surface 43 of the hollow cylindrical projection 41 of the first cover portion 30. The groove 45 is elongate and extends substantially in the direction of the axis of rotation of the driven member X. When the rib 69 of the annular mounting ring 61 is received in the groove 45 of the hollow cylindrical projection 41 of the first cover portion 30 the rib 69 abuts the groove 45 to prevent rotation of the annular mounting ring 61 and the accessory 60 as a whole relative to the first cover portion 30. In another form, not illustrated, the annular mounting ring 61 does not have the rib 69. In this arrangement, the annular mounting ring 61 is able to rotate about the hollow cylindrical projection 41 despite the presence of the groove 45.

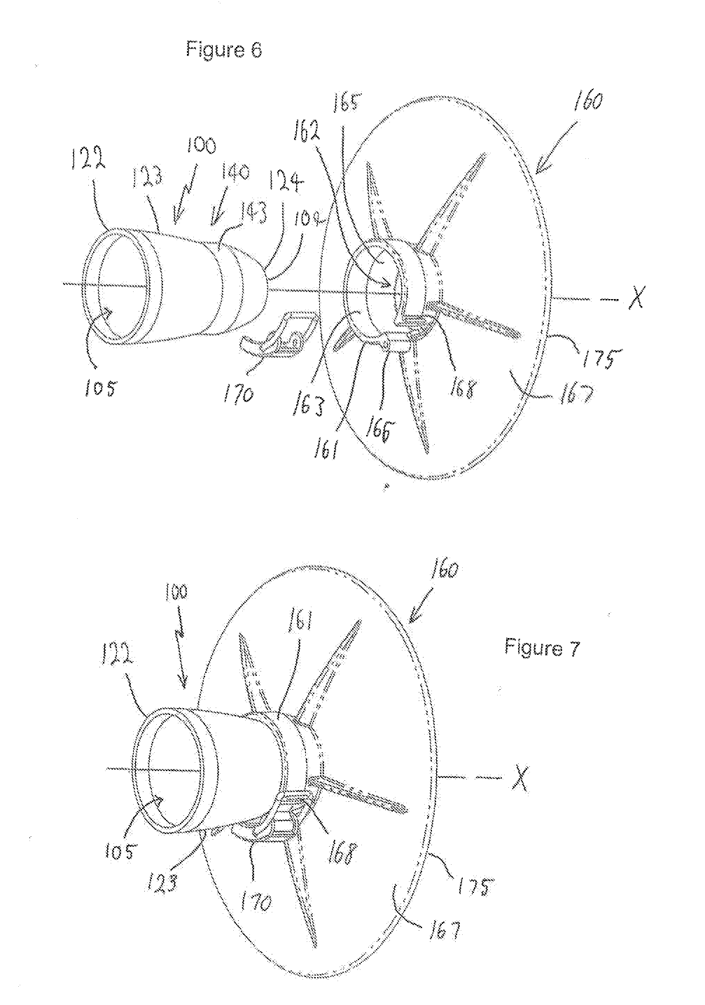

Referring to FIGS. 6 and 7 another embodiment of the invention is illustrated. In this embodiment, a cover 100 is provided that is configured to surround the driven member (not shown) of the power tool 10 of FIG. 1. The cover 100 includes an internal hollow opening 105 for receiving a driven member (not shown) of the power tool 10 therewithin. The cover 100 extends from a rearward end 122 to a forward end 124. In the cover 100 of the embodiment illustrated in FIGS. 6 and 7 the rearward end 122 is configured to be directly connected to the front end 7 of the tool body 15 in the same manner as the cover 20 is connected to the tool body 15 in the embodiment illustrated in FIG. 1.

The cover 100 has a substantially hollow internal volume that is configured to receive the driven member of the power tool 10 therewithin. The driven member is configured for releasable connection with the working element such as a drill or screwdriver bit (not shown) which protrudes through a forward opening 104 at the forward end 124 of the cover 100. The cover 100 includes an external tapered surface 123 extending from the rearward end 122 to the forward end 124. At a point intermediate the rearward and forward ends 122, 124 the external tapered surface 123 is interrupted by an embodiment of the first accessory attachment facility 140 that is different to the embodiment of the first accessory attachment facility 40 illustrated in FIGS. 1 to 5. The first accessory attachment facility 140 is in the form of a radially outwardly facing annular surface 143 which extends around the axis of rotation of the driven member X as well as substantially in the direction of the axis of rotation of the driven member X. Thus, the radially outwardly facing annular surface 143 is substantially in the form of an annular ring interrupting the external tapered surface 123 intermediate the rearward and forward ends 122, 124 of the cover 100.

The radially outwardly facing annular surface 143 is configured for face to face engagement with a radially inwardly facing annular mounting surface 163 of an accessory 160 as shown in the embodiments illustrated in FIGS. 6 and 7. The accessory 160 is a dust shroud that is configured to retain dust generated as a result of drilling or performing some other type of work by a working element on a workpiece when the working element is connected to, and rotated by, the driven member about the axis of rotation X thereof. The accessory 160 includes a disc shaped portion 167 including a centrally located opening 162 for receiving the forward end 124 of the cover 100 therewithin and for enabling a working element (not shown) attached to the driven member to pass therethrough. An annular mounting ring 161 extends transversely from the disc portion 167 substantially in the direction of the axis of rotation of the driven member X and defines an opening for receiving the radially outwardly facing annular surface 143 of the cover 100. The annular mounting ring 161 includes a radially inwardly facing mounting surface 163 for coming into face to face contact with the radially outwardly facing annular surface 143 of the cover 100. The annular mounting ring 161 may be either a partially complete or a complete ring and includes a latching arrangement in the form of a pair of latch receiving members 166, 168 and a latch 170. The latch 170 is configured to mate with the latch receiving members 166, 168 on opposite ends of the annular mounting ring 161 to releasably constrict the annular mounting ring 161 around the radially outwardly facing annular surface 143 of the cover 100. Releasable constriction of the annular mounting ring 161 around the radially outwardly facing annular surface 143 of the cover 100 thereby releasably engages the radially inwardly facing annular mounting surface 163 in face to face engagement with the radially outwardly facing annular surface 143 of the cover 100 and thereby releasably attaches the accessory 160 to the cover 100.

The disc portion 167 of the accessory 160 includes a dust collecting surface 175 which is substantially transverse to the axis of rotation of the driven member X and which faces away from the cover 100 and the tool body 15. The dust collecting surface 175 is advantageous for collecting dust when the power tool 10 is being used to perform work on a workpiece that is prone to producing dust or other contaminants when work is performed on it. The dust collecting surface 175 is particularly advantageous when the workpiece is a ceiling and the power tool 10 is being used to drill or cut a hole through the ceiling as the dust collecting surface 175 is capable of collecting the dust generated as a result of the hole being drilled or cut through the ceiling which would ordinarily fall as a result of gravity onto a user operating the power tool 10. Because the cover 100 is directly connected to the tool body 15 the cover 100 does not rotate with the driven member. Thus, the disc portion 167 of the dust shroud accessory 160 also does not rotate with the driven member or the working element attached thereto. Accordingly, the dust shroud accessory 160 is substantially stationary relative to the workpiece when the power tool 10 is being used to perform work thereon and does not tend to cause dust collected thereon to the disbursed. In one form, the dust shroud accessory 160 may be partially or completely formed out of a transparent material to enable a user to see the workpiece when the power tool 10 is being used to perform work thereon.

The dust shroud accessory 160 further includes a tapered surface 165 between the annular mounting ring 161 and the disc portion 167. The tapered surface 165 is configured to abut against a portion of the external tapered surface 123 of the cover portion between the radially outwardly facing annular surface 143 and the forward end 124 thereof. The abutment between the external tapered surface 123 of the cover 100 and the internal tapered surface 165 of the accessory 160 serves to provide additional support between the cover 100 of the power tool 10 and the accessory 160 and restrict the amount of relative movement therebetween and between the accessory 160 and the power tool 10. The abutment between the external tapered surface 123 of the cover 100 and the internal tapered surface 165 of the accessory 160 also serves to provide additional support for the accessory 160 against movement relative to the axis of rotation of the driven member X.

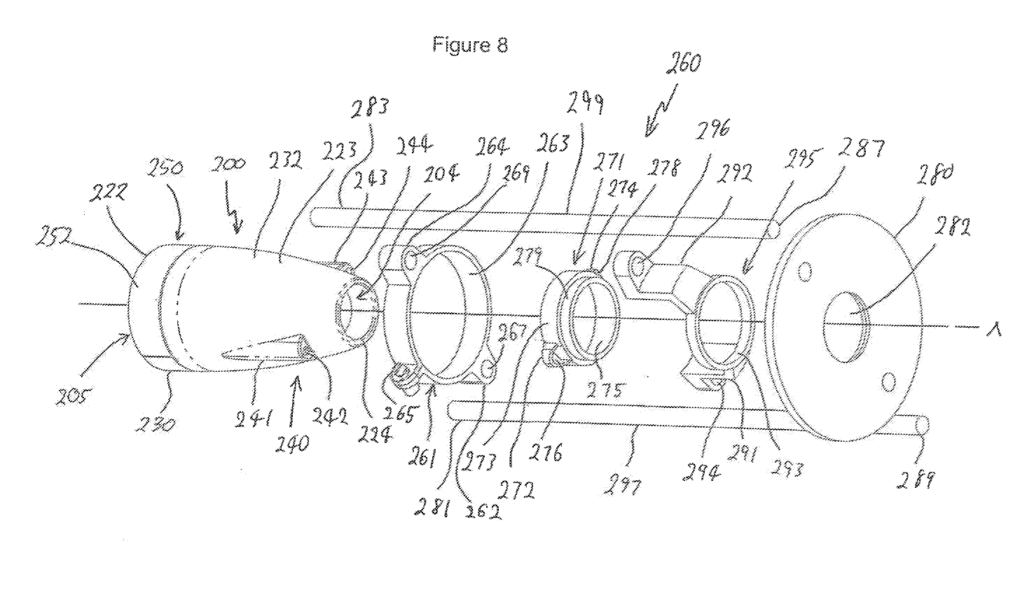

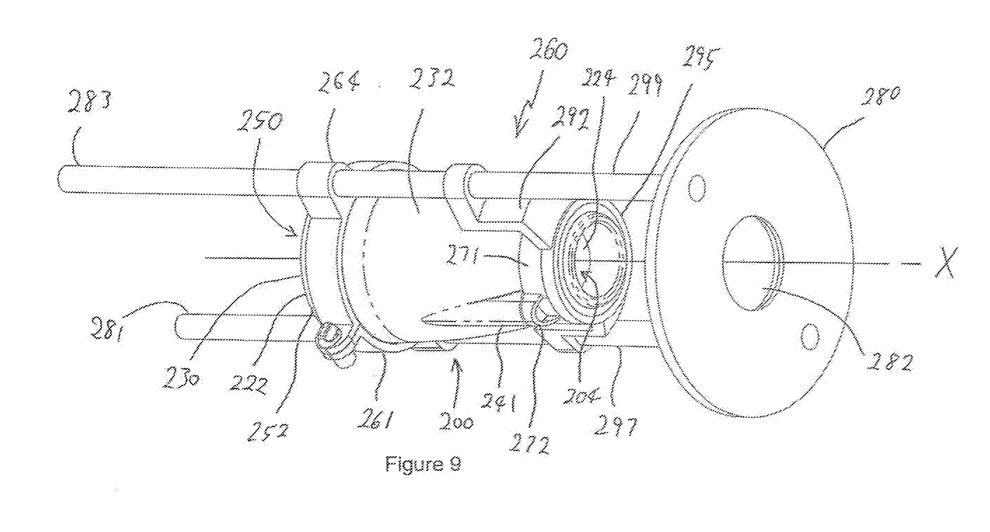

Referring to FIGS. 8 and 9 another embodiment of the invention is illustrated. The embodiment illustrated in FIGS. 8 and 9 includes a cover 200 for direct connection to the tool body 15 of the power tool 10 of FIG. 1 as well as an accessory 260 for releasable attachment to the cover 200. The cover 200 includes a rearward end 222 and a forward end 224 and an external tapered surface 223 extending between the rearward end 222 and the forward end 224. The rearward end 222 is configured for direct connection to the front end 7 of the tool body 15 in the same manner as the cover 20 is directly connected to the front end 7 of the tool body 15 in the embodiment illustrated in FIG. 1. A portion of the tool body 15 including the front end 7 to which the cover 200 is attached is illustrated in FIGS. 8 and 9.

The cover 200 includes an internal hollow opening 205 for receiving a driven member (not shown) of the power tool 10 therewithin. The driven member is configured for releasable connection with a working element such as a drill or screwdriver bit (not shown) which protrudes through a forward opening 204 at the forward end 224 of the cover 200. The cover 200 includes a first accessory attachment facility 240 positioned on the radially outwardly facing external tapered surface 223 of the cover 200 between the rearward end 222 and the forward end 224 of the cover 200 along the direction of the axis of rotation of the driven member X.

The first accessory attachment facility 240 is configured for releasable attachment of the accessory 260 to the radially outwardly facing external tapered surface 223 of the cover 200. The first accessory attachment facility 240 includes means for releasably attaching the accessory 260 to the cover 200 in positions located on opposite sides of the axis of rotation of the driven member X. In the embodiment illustrated in FIGS. 8 and 9, the first accessory attachment facility 240 includes one or more openings 242, 244 extending substantially in the direction of the axis of rotation of the driven member X and disposed in the external tapered surface 223 of the cover 200. The arrangement illustrated in FIGS. 8 and 9 includes a pair of the openings 242, 244 positioned on opposite sides of the axis of rotation of the driven member X, however, it is to be appreciated that the cover 200 may have only one of the openings 242, 244 or more than two of the openings 242, 244.

As can be seen in the embodiments illustrated in FIGS. 8 and 9, the openings 242, 244 are located within respective ribs 241, 243 that project from the external tapered surface 223 of the cover 200 substantially in the direction of the axis of rotation of the driven member X. The openings 242, 244 are configured to receive therethrough an elongate member (not shown) for fastening the accessory 260 to the cover 200. The elongate member may be a rod configured for an interference fit within the opening 242, 244 or it may be a threaded fastener configured for threaded engagement with a corresponding thread disposed within the openings 242, 244 for attachment of the accessory 260 to the cover 200.

In the embodiment illustrated in FIGS. 8 and 9, the front end 7 of the tool body 15 includes a second accessory attachment facility 250. The second accessory attachment facility 250 is, like the first accessory attachment facility 240, configured for releasable attachment of the accessory 260 thereto. The second accessory attachment facility 250 may be configured for attachment of the accessory 260 thereto in a position spaced apart from the first accessory attachment facility 240 along the direction of the axis of rotation of the driven member X. The second accessory attachment facility 250 includes a radially outwardly facing annular surface 252 which extends around and in the direction of the axis of rotation of the driven member X. Thus, the radially outwardly facing annular surface 252 forms an annular ring around the axis of rotation of the driven member X. The radially outwardly facing annular surface 252 is configured for face to face engagement with a radially inwardly facing annular surface 263 of an annular mounting ring 261 of the accessory 260.

The accessory 260 of the embodiment illustrated in FIGS. 8 and 9 is a drill plunge depth guide that is configured, when attached to the power drill 10, to facilitate a predetermined plunge depth for a drill bit (not shown) attached to the driven member (not shown) into a workpiece (not shown). The accessory 260 of the embodiment illustrated in FIGS. 8 and 9 is also configured so that when a drill bit that is attached to the driven member is drilled into a workpiece the accessory 260 ensures that the drill bit enters the workpiece perpendicularly thereto.

The assembled cover 200 and accessory 260 are illustrated in FIG. 9. The accessory 260 includes a first annular mounting ring 261, a second annular mounting ring 271, a pivoting mounting ring 295 and a workpiece contacting member 280. The accessory 260 achieves a predetermined plunge depth of a drill bit by providing a predetermined spacing between the forward end 224 of the cover 200 and the workpiece contacting member 280 such that a predetermined length of a portion of the drill bit protrudes through a centrally located opening 282 within the workpiece contacting member 280.

The first annular mounting ring 261 is a partially complete ring member with a ring diameter adjusting device 265, which may be in the form of a screw, extending between opposite ends of the partially enclosed first annular mounting ring 261. As illustrated in FIG. 9, the first annular mounting ring 261 is configured to receive the radially outwardly facing annular surface 252 of the second accessory attachment facility 250 of the cover 200 therewithin. The ring diameter adjusting device 265 can be adjusted to enable the radially inwardly facing annular surface 263 of the first annular mounting ring 261 to tightly grip the radially outwardly facing annular surface 252 of the second accessory attachment facility 250 of the cover 200. Thus, the first annular mounting ring 261 and the second accessory attachment facility 250 are operable to support the accessory 260 in position relative to the cover 200 to prevent relative movement therebetween.

The second annular mounting ring 271 includes a radially inwardly facing annular surface 275 that is tapered in the direction of the axis of rotation of the driven member X to fit in face to face contact around the external tapered surface 223 of the cover 200 between the first accessory attachment facility 240 and the forward end 224 thereof. The second annular mounting ring 271 also includes a pair of radially outwardly extending projections 272, 274 extending from a first outwardly facing annular surface 273 thereof. Each of the projections 272, 274 includes a respective opening 276, 278 for receiving an elongate member therethrough. The elongate members received through each of the openings 276, 278 of the second annular ring 271 are also received within the openings 242, 244 of the first accessory attachment facility 240 of the cover 200 to thereby releasably attach the second annular mounting ring 271 to the cover 200.

The second annular mounting ring 271 includes a second outwardly facing annular ring surface 279 that is located forward of the first outwardly facing annular surface 273. The second annular mounting ring 271 is configured to be received within the pivoting mounting ring 295. The second annular outwardly facing ring surface 279 of the second annular mounting ring 271 contacts an inwardly facing annular ring 293 within the pivoting mounting ring 295 such that the pivoting mounting ring 295 is pivotally engaged with the second annular mounting ring 271. Thus, the pivoting mounting ring 295 is pivotal relative to the second annular mounting ring 271 and the cover 200.

The pivoting mounting ring 295 includes a pair of radially outwardly extending arms 291, 292 which have respective openings 294, 296. The first annular mounting ring 261 also includes a pair of radially outwardly extending projections 262, 264 which respectively include openings 267, 269. The openings 267, 269 of the first annular mounting ring 261 and the openings 294, 296 of the pivoting mounting ring 295 are oriented in the direction of the axis of rotation X of the driven member and are each configured to line up with each other to receive an elongate member 297, 299. The elongate members 297, 299 are each respectively elongate rods that extend from a respective distal end 289, 287 to a proximal end 281, 283. The distal end 289, 287 of each of the elongate members 297, 299 are respectively connected to the workpiece contacting member 280 as illustrated in FIG. 9. Each of the elongate members 297, 299 extend from the workpiece contacting member 280 through respective openings 294, 296 of the pivoting mounting ring 295 and respective openings 267, 269 of the first annular mounting ring 261. The proximal end 281, 283 of each of the elongate members 297, 299 are respectively connected to the first annular mounting ring 261 within the openings 267, 269 of the first annular mounting ring 261. Thus, when the first annular mounting ring 261 is mounted to the second accessory attachment facility 250 and the second annular mounting ring 271 and pivoting mounting ring 295 are connected to the first accessory attachment facility 240 the elongate members 297, 299 act to maintain the workpiece contacting member 280 at a predetermined distance from the forward end 224 of the cover 200 to facilitate the plunge depth guide function of the accessory 260.

The accessory 260 achieves a predetermined plunge depth of a drill bit by providing a predetermined spacing between the forward end 224 of the cover 200 and the workpiece contacting member 280. The elongate members 297, 299 are slidable within the openings 267, 269 of the first annular mounting ring 261 and the openings 294, 296 of the pivoting mounting ring 295 to enable the spacing between the forward end 224 of the cover 200 and the workpiece contacting member 280 to be adjusted. When a suitable spacing is achieved the position of the elongate members 297, 299 relative to the openings 267, 269 of the first annular mounting ring 261 and the openings 294, 296 of the pivoting mounting ring 295 can be fixed by any suitable means. For example, a device (not shown) which may be incorporated into either of the openings 267, 269 of the first annular mounting ring 261 or either of the openings 294, 296 of the pivoting mounting ring 295 that is capable of releasably clamping or providing releasable frictional engagement with either one or both of the elongate members 297, 299 to substantially prevent relative movement therebetween. Alternatively, a device (not shown) may be incorporated into either of the elongate members 297, 299 that is capable of releasably clamping or providing a releasable frictional engagement with either one or both of the openings 267, 269 of the first annular mounting ring 261 or either of the openings 294, 296 of the pivoting mounting ring 295 to substantially prevent relative movement therebetween.

In the embodiments illustrated in FIGS. 8 and 9, the cover 200 is made up of a first cover portion 230 and a second cover portion 232 whereby the first and second cover portions 230, 232 are pivotally connected to each other such that the first cover portion 230 and the second cover portion 232 may rotate relative to each other about the axis of rotation of the driven member X. The first cover portion 230 includes the rearward end 222 of the cover 200 which is fixedly connected to the front end 7 of the tool body 15. Thus, the first cover portion 230 does not rotate relative to the tool body 15. On the contrary, the second cover portion 232 which includes the forward end 224 of the cover 200 is rotatable relative to the first cover portion 230 and the tool body 15. The first cover portion 230 and the second cover portion 232 may be rotatable relative to each other for any suitable purpose such as to provide a selector arrangement for selecting an amount of torque applied by the drive means (not shown) to the driven member (not shown). In another embodiment, the first cover portion 230 and the second cover portion 232 of the cover 200 are integrally formed and are not rotatable relative to each other about the axis of rotation of the driven member X.

Referrring to the accessory 260 of FIGS. 8 and 9, because the first annular mounting ring 261 is releasably connected to the second accessory attachment facility 250 and the first cover portion 230 the workpiece contacting member 280 remains stationary relative to the tool body 15 and does not rotate with the second cover portion 232. Rotation of the second cover portion 232 relative to the tool body 15 and the workpiece contacting member 280 is facilitated when the accessory 260 is attached to the first accessory attachment facility 240 by the second annular mounting ring 271 being rotatably connected to the pivoting mounting ring 295. Thus, when the second cover portion 232 is rotated relative to the first cover portion 230 the second annular mounting ring 271 also rotates with the second cover portion 232, however, the pivoting mounting ring 295 does not rotate with the second cover portion 232 but remains stationary relative to the first cover portion 230.

In another form, the component described herein and illustrated in FIGS. 8 and 9 as the first cover portion 230 may be a front part of the tool body 15 that contains the front end 7 of the tool body 15 and the component described herein as the second cover portion 232 may make up the cover 200 in its entirety. Accordingly, the front part 230 of the tool body 15 includes the second accessory attachment facility 250 and the cover 200 includes the first accessory attachment facility 240. The cover 200 may be rotatably connected to the front part 230 of the tool body 15 at the front end 7 thereof for any suitable purpose such as to provide a selector arrangement for selecting an amount of torque applied by the drive means (not shown) to the driven member (not shown). In embodiments where the front part 230 of the tool body 15 and the cover 200 are rotatable relative to each other the about the axis of rotation of the driven member X the first accessory attachment facility 240 and the second accessory attachment facility 250 are also rotatable relative to each other. When the accessory 260 is coupled to the first and second accessory attachment facilities 240, 250 and the cover 200 is rotated relative to the front part 230 of the tool body 15 the second annular mounting ring 271 rotates with the cover 200, however, the pivoting mounting ring 295 does not rotate with the cover 200 but remains stationary relative to the front portion 230 of the tool body 15.

The elongate members 297, 299 of the accessory 260 are supported by the first and second accessory attachment facilities 240, 250 at different spaced apart locations on the cover 200 along the direction of the axis of rotation of the driven member X. The workpiece contacting member 280 of the accessory 260 is maintained in a relatively stable position relative to the cover 200 and the tool body 15 and the driven member (not shown) irrespective of the rotation of the second cover portion 232 relative to the first cover portion 230 and the workpiece contacting member 280.

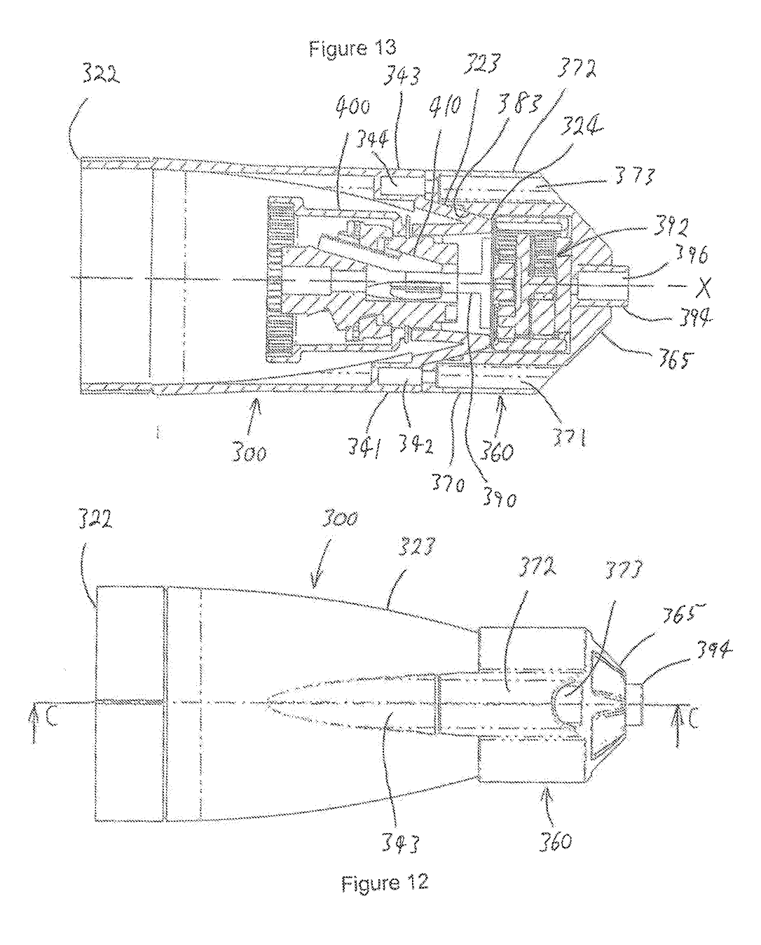

FIGS. 10 to 13 illustrate another embodiment of a cover 300 for direct connection to the front end 7 of the tool body of FIG. 1. The cover 300 includes a rearward end 322 and a forward end 324 with the rearward end 322 being directly connected to the front end 7 of the tool body 15. The cover 300 surrounds a chuck (not shown) that is configured to releasably hold a working element such as a drill or screw driver bit. The cover 300 of the embodiment illustrated in FIGS. 10 to 13 is substantially the same as the cover 200 of the embodiment illustrated in FIGS. 8 and 9 in that the cover 300 includes a first accessory attachment facility 340 intermediate the rearward end 322 and the forward end 324 which involves a pair of ribs 341, 343 projecting from an external tapered surface 323 in the direction of the axis of rotation of the driven member X. Each of the ribs 341, 343 include respective openings 342, 344 arranged to receive an elongate member (not shown) therewithin. The openings 342, 344 may each respectively include a threaded internal surface for receiving the threaded elongate member therewithin. A portion of the tapered external surface 323 between the first accessory attachment facility 340 and a forward end 324 is configured to be received within a tapered opening of an accessory 360. The accessory 360 illustrated in FIGS. 10 to 13 is a gearbox.

The gearbox 360 is configured to produce either a reduction in output rotation speed relative to the speed of rotation of the driven member or an increase in output rotation speed relative to the rotation speed of the driven member. The gearbox 360 includes a housing 365 which is a substantially cylindrical shaped member containing a plurality of gearbox components which are shown in FIG. 13. The housing 365 has a substantially cylindrical shaped radially outwardly facing surface 367 extending substantially in the same direction as the axis of rotation of the driven member X. The housing 365 further includes a pair of projecting ribs 370, 372 on substantially opposite sides of the radially outwardly facing surface 367 of the housing 365. The ribs 370, 372 extend in substantially the same direction as the axis of rotation of the driven member X and respectively include an opening 371, 373 for receiving an elongate member (not shown) therethrough. The elongate member received through the openings 371, 373 is also received through respective openings 342, 344 of the cover 300. The openings 371, 373 of the gearbox 360 may include respective internal threads for threaded engagement with an elongate threaded member. Similarly, the openings 342, 344 within the cover 300 may also be internally threaded for threaded engagement with a threaded version of the elongate member.

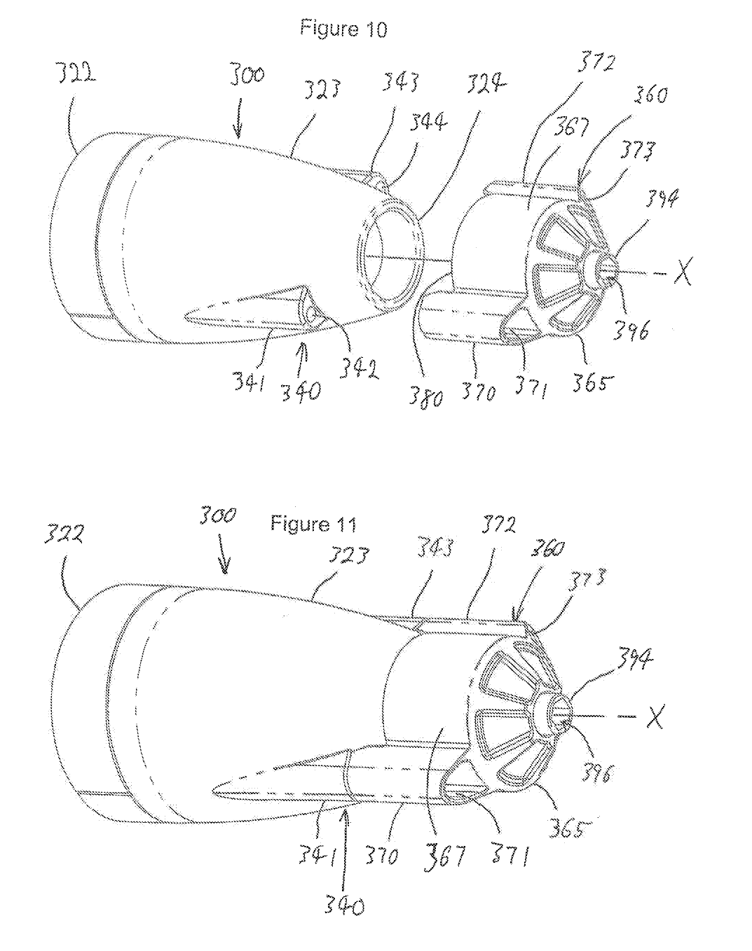

As illustrated in FIG. 11, when the gearbox 360 is brought into engagement with the cover 300 the forward end 324 of the cover 300 is received within an opening 380 in the gearbox 360. The opening 380 within the gearbox 360 may be defined by a tapered radially inwardly facing mounting surface 383. As shown in the cross-section of FIG. 13, the tapered radially inwardly facing mounting surface 383 of the gearbox 360 comes into face to face engagement with the portion of the tapered external surface 323 of the cover 300 between the first accessory attachment facility 340 and the forward end 324. The openings 371, 373 of the gearbox 360 receive the elongate members (not shown) therethrough to fasten the gearbox 360 to the cover 300.

Referring to FIG. 13, the gearbox 360 includes an input shaft 390 which extends rearwardly from the gearbox 360 to be received by the driven member 400 of the power tool 10. In the embodiment illustrated in FIG. 13, the driven member 400 is a drill chuck that includes a plurality of gripping jaws 410 that are configured to be adjusted relative to the axis of rotation of the driven member X to grip or release the input shaft 390 of the gearbox 360. The input shaft 390 extends into a gear arrangement 392 located within the housing 365 of the gearbox 360. The gear arrangement 392 may take any suitable form and may include one or more gear reduction stages or one or more rotation speed reduction stages or one or more rotation speed increase stages. An output shaft 394 extends forward from the gear arrangement 392 and the housing 365. The gearbox 360 is configured such that the speed of rotation of the output shaft 394 about the axis of rotation of the driven member X can be increased or reduced relative to the speed of rotation of the driven member 400 about the axis of rotation of the driven member X. The output shaft 394 includes a hex-shaped opening 396 that is configured to receive a hex-shaped bit therewithin.

The arrangement of the gearbox 360 as a rotation speed reduction gearbox 360 is useful in applications where the bit to be rotated by the power tool 10 functions best when rotating at a relatively low speed compared to the speed of rotation of a driven member. For example, a speed reduction arrangement of the gearbox 360 of FIGS. 10 to 13 in combination with a power tool 10 in the form of a power drill as illustrated in FIG. 1 is particularly suitable where the bit to be attached to the output shaft 394 of the gearbox 360 is a paint stirring device. This is because for a paint stirring device it is preferable for the device to rotate at a relatively low speed of rotation relative to the speed of rotation of the driven member of the power tool in order to reduce the load on the power tool's motor and to reduce spattering of paint.

In another form not illustrated in the figures, the first accessory attachment facility 240 may have a first accessory, such as the light emitting accessory 60 of the embodiment illustrated in FIGS. 4 and 5 or the dust shroud accessory 160 of the embodiment illustrated in FIGS. 6 and 7 or any other suitable type of accessory, releasably attached thereto and the second accessory attachment facility 250 may have a second accessory releasably attached thereto. In another form, the cover may include a third accessory attachment facility (not shown) configured for releasable attachment thereto of any one of the accessories described herein or any other suitable type of accessory. At the same time that an accessory is attached to the third accessory attachment facility it may also be possible for the first and second accessory attachment facilities 240, 250 to provide for releasable attachment thereto of another one or more of the accessories described herein or any other suitable type of accessory.

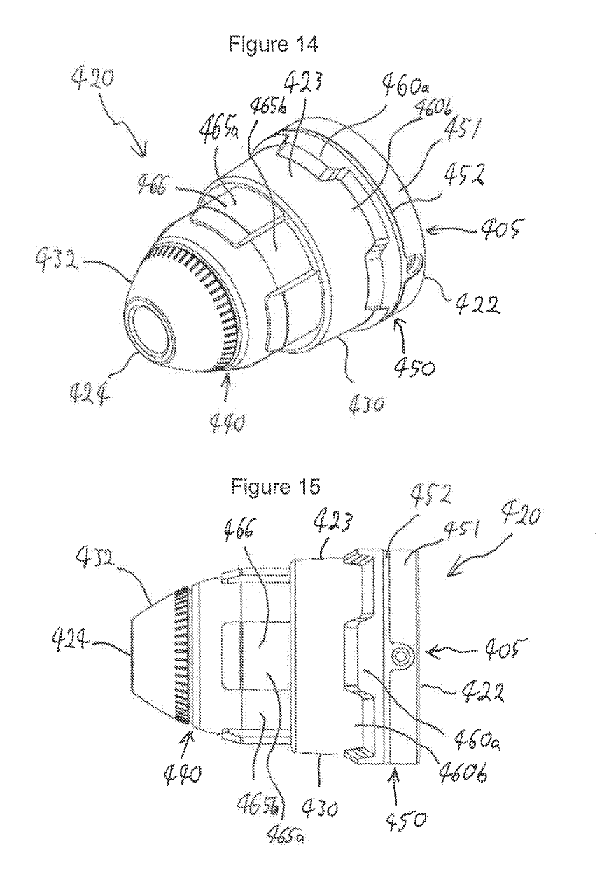

Referring to FIGS. 14 and 15, another embodiment of the cover 420 is shown in which the cover 420 is made up of a first cover portion 430 and a second cover portion 432. The cover 420 includes a rearward end 422 and a forward end 424 with the rearward end 422 being directly connected to the front end 7 of the tool body 15 of FIG. 1. The cover 420 surrounds the chuck of the power tool 10. The cover 420 includes an internal hollow opening 405 for receiving the driven member of the power tool 10 therewithin. The first cover portion 430 and the second cover portion 432 are configured to be removably coupled together. To achieve removable coupling of the first cover portion 430 and the second cover portion 432, the first cover portion 430 includes a hollow cylindrical projection (not shown) having a radially outward facing surface (not shown) with a first thread (not shown) disposed thereon. The second cover portion 432 includes a passage (not shown) configured to receive the hollow cylindrical projection therewithin. The passage includes a radially inwardly facing surface (not shown) and a second thread (not shown) disposed thereon. The first thread and the second thread are configured to mate with each other upon insertion of the hollow cylindrical projection into the passage to removably couple the first cover portion 430 and the second cover portion 432 together. In other words, the means for removable coupling of the first cover portion 430 and the second cover portion 432 of the embodiment of the cover 420 of FIGS. 14 and 15 is substantially the same as in the cover 20 of FIGS. 1 to 5.

In the embodiment illustrated in FIGS. 14 and 15, the cover 420 includes a first accessory attachment facility 440 made up of the removable coupling of the first cover portion 430 and the second cover portion 432 together. The first accessory attachment facility 440 of the embodiment of FIGS. 14 and 15 is substantially the same as the first accessory attachment facility 440 of the embodiment of FIGS. 1 to 5.

The second cover portion 432 includes a second attachment facility 450 that is in the form of an annular ring 451 about the periphery of the second cover portion 432 and about the axis of rotation of the driven member X and located adjacent to the rearward end 422 of the cover 420. The annular ring 451 includes an annular groove 452. The annular ring 451 of the second attachment facility 450 is configured to receive an annular mounting ring of an accessory similar to the annular mounting ring 261 of the accessory 260 of the embodiment of FIGS. 8 and 9. The annular groove 452 is configured to receive a protrusion extending radially inwardly from the annular mounting ring. The purpose of the annular groove 452 and the protrusion received therein is to enable the annular mounting ring 261 to be loosened from the annular ring 451 and rotated relative to the annular ring 451 whilst the protrusion remains within the annular groove 452 and prevents the mounting ring 452 when in the loosened state from sliding off the annular ring 451.

The first cover portion 430 includes an external surface 423 that extends from the rearward end 422 of the cover 420 to the second cover portion 432. The external surface 423 includes a first set of consecutive ridges 460a and troughs 460b located immediately adjacent to the second attachment facility 450 and about the periphery of the second cover portion 432 and about the axis of rotation of the driven member X.

The external surface 423 includes a second set of consecutive ridges 465a and troughs 465b located between the first set of ridges 460a and troughs 460b and the second cover portion 432 and about the periphery of the second cover portion 432 and about the axis of rotation of the driven member X. The second set of ridges 465a each have a mounting surface 466 which comprises a section of an annular ring about the periphery of the second cover portion 432 and about the axis of rotation of the driven member X. Thus, the mounting surfaces 466 of the second ridges 465a provide a discontinuous annular mounting ring about the periphery of the second cover portion 432 and about the axis of rotation of the driven member X which is capable of receiving an annular mounting ring of an accessory similar to the annular mounting ring 261 of the accessory 260 of the embodiment of FIGS. 8 and 9.

The first accessory attachment facility 440 is operable for clamping an attachment (not shown) between the first cover portion 430 and the second cover portion 432. The first and second sets of ridges and troughs 460, 465 can cooperate with complimentary shaped ridges and troughs (not shown) of an attachment provided with such ridges and troughs on a surface thereof. Thus, when such an accessory is clamped by the first accessory attachment facility 440 interengagement between one or both sets of the ridges and troughs 460, 465 of the first cover portion 430 with the complimentary ridges and troughs of the accessory can act to prevent rotation of the accessory relative to the cover portion 430 about the axis of rotation of the driven member X.

Those skilled in the art will appreciate that the invention described herein is susceptible to variations and modifications other than those specifically described. It is to be understood that the invention includes all such variations and modifications which fall within the spirit and scope of the invention.

Future patent applications may be filed in Australia or overseas on the basis of, or claiming priority from, the present application. It is to be understood that the following provisional claims are provided by way of example only and are not intended to limit the scope of what may be claimed in any such future application. Features may be added to, or omitted from, the provisional claims at a later date so as to further define or re-define the invention or inventions.

1. A power tool including:
a tool body
a rotatable driven member extending forward from the tool body for gripping and rotating a working element about an axis of rotation;
a cover surrounding the driven member having opposite rearward and forward ends with the rearward end being directly connected to the tool body so that the cover does not rotate with the driven member, the cover including at least one accessory attachment facility configured to facilitate releasable attachment of an accessory to the cover between the rearward and forward ends along the direction of the axis of rotation of the driven member.

2. The power tool of claim 1, wherein the accessory attachment facility is positioned on a radially outwardly facing surface of the cover between the rearward and forward ends along the direction of the axis of rotation of the driven member, the accessory attachment facility being configured for releasable attachment of an accessory to the radially outwardly facing surface of the cover.

3. canceled

4. The power tool of claim 1, wherein the accessory attachment facility is configured for releasable attachment of an accessory to the cover in at least two positions on opposite sides of the axis of rotation of the driven member.

5. The power tool of claim 1, wherein the accessory attachment facility includes an opening for receiving therethrough an elongate member for fastening an accessory to the cover.

6. canceled

7. The power tool of claim 1, wherein the cover is made up of separate first and second cover portions.

8. The power tool of claim 7, wherein the accessory attachment facility is provided by removably coupling the first and second cover portions together and securing an accessory therebetween.

9. The power tool of claim 7, wherein the first and second cover portions include a pair of opposing surfaces that are configured to clamp an accessory therebetween when the first and second cover portions are coupled together.

10-11. (canceled)

12. The power tool of claim 7, wherein one of the first and second cover portions includes a projection that fits into a passage within the other one of the first and second cover portions when the first and second cover portions are coupled together.

13. (canceled)

14. The power tool of claim 12, wherein the projection includes a radially outwardly facing surface with an elongate rib or groove extending in the direction of the axis of rotation of the driven member for engaging a respective groove or rib on an accessory to prevent rotational movement of the accessory relative to the cover.

15-16. (canceled)

17. The power tool of claim 1, wherein the accessory attachment facility includes a radially outwardly facing annular surface of the cover extending in substantially the same direction as the axis of rotation of the driven member, wherein the annular surface is configured for face to face engagement with a radially inwardly facing annular mounting surface of an accessory.

18. (canceled)

19. The power tool of claim 1, wherein the cover includes a second accessory attachment facility configured for releasable attachment of an accessory thereto between the rearward and forward ends of the cover, the accessory attachment facilities being spaced apart from each other along the direction of the axis of rotation of the driven member.

20-22. (canceled)

23. A power tool accessory configured for use with a power tool having a tool body, a rotatable driven member extending forward from the tool body for gripping and rotating a working element about an axis of rotation and a cover surrounding the driven member having opposite rearward and forward ends with the rearward end being directly connected to the tool body so that the cover does not to rotate with the driven member, the cover being configured to facilitate releasable attachment of an accessory to the cover between the rearward and forward ends along the direction of the axis of rotation of the driven member,
the accessory including at least one power tool attachment facility configured to facilitate releasable attachment of the accessory to the cover between the rearward and forward ends along the direction of the axis of rotation of the driven member.

24. The power tool accessory of claim 23, wherein the accessory includes an annular mounting ring for receiving an annular surface of the cover therethrough.

25. The power tool accessory of claim 24, wherein the annular mounting ring includes a pair of opposite annular surfaces configured to be clamped between a pair of opposing surfaces of first and second portions of the cover.

26. (canceled)

27. The power tool accessory of claim 24, wherein the annular mounting ring includes a radially inwardly facing annular surface with a rib or groove for engaging a respective groove or rib of the cover to prevent rotational movement of the accessory relative to the cover.

28. (canceled)

29. The power tool accessory of claim 24, wherein the annular mounting ring includes a radially inwardly facing annular surface configured for face to face engagement with a radially outwardly facing annular surface of the cover.

30-32. (canceled)

33. The power tool accessory of claim 23, wherein the power tool attachment facility is configured for releasable attachment of the cover to the accessory in at least two positions on opposite sides of the axis of rotation of the driven member.

34-35. (canceled)

36. The power tool accessory of claim 23, wherein the accessory includes a second power tool attachment facility configured for releasable attachment to the cover at a position between the rearward and forward ends of the cover, the power tool attachment facilities being spaced apart from each other along the direction of the axis of rotation of the driven member.

37. (canceled)

38. The power tool accessory of claim 23, wherein the accessory is any one of a light emitting device, a drill plunge depth guide, a dust shroud, a gearbox or a paint stirring attachment.

39-46. (canceled)

47. A power tool and accessory system including a power tool and an accessory, the power tool having a tool body, a rotatable driven member extending forward from the tool body for gripping and rotating a working element about an axis of rotation, a cover surrounding the driven member having opposite rearward and forward ends with the rearward end being directly connected to the tool body so that the cover does not to rotate with the driven member, the cover being configured to facilitate releasable attachment of the accessory to the cover between the rearward and forward ends along the direction of the axis of rotation of the driven member.

48-49. (canceled)
